(19) United States
(12) Patent Application Publication
(10) Pub. No.: US 2009/0296778 A1
(43) Pub. Date: Dec. 3, 2009

(54) FLUORESCENT TEMPERATURE SENSOR

(75) Inventors: Seiichiro Kinugasa, Tokyo (JP); Atsushi Kato, Tokyo (JP)

Correspondence Address: DARBY & DARBY P.C., P.O. BOX 770, Church Street Station, New York, NY, 10008-0770, US

(73) Assignee: Yamatake Corporation, Tokyo (JP)

(21) Appl. No.: 12/470,687

(22) Filed: May 22, 2009

(30) Foreign Application Priority Data
May 27, 2008 (JP) 2008-138299

(51) Int. Cl. G01K 11/00

(52) U.S. Cl. 374/161; 374/E11.001

(57) ABSTRACT

To use a simple structure to provide a fluorescent temperature sensor with increased accuracy through increasing the fluorescent light intensity of the fluorescent materials. A fluorescent temperature sensor for producing a temperature signal from a fluorescent light of a fluorescent material that is optically stimulated is provided with an LED for projecting light onto the fluorescent material, a photodiode for receiving the fluorescent light that is emitted by the fluorescent material, and a signal processing circuit for generating the temperature signal from the output of the photodiode. Optical fibers for the projected light, for conveying the light from the LED to the fluorescent material, and optical fibers for the received light, for conveying the light from the fluorescent material to the photodiode, are separated and independent from each other on one end side thereof, facing the respective elements, and on the other end side, which faces the fluorescent material, are bundled so as to be mixed together.

### CROSS REFERENCE TO PRIOR APPLICATIONS

The present application claims priority under U.S.C. §119 to Japanese Patent Application No. 2008-138299, filed May 27, 2008. The content of the application is incorporated herein by reference in its entirety.

### FIELD OF TECHNOLOGY

The present invention relates to a fluorescent temperature sensor for generating a temperature signal from fluorescent light of a fluorescent material that is optically stimulated.

### BACKGROUND OF THE INVENTION

As an example of this type of fluorescent temperature sensor, there is the known example of a light source and a light receiving element being spatially separated, as illustrated in U.S. Pat. No. 5,470,155. In this type of fluorescent temperature sensor, the other end of an optical fiber wherein one end faces a fluorescent material is both illuminated by the light from a light source, through a half mirror or a dichroic mirror, and the fluorescent light that is produced by the fluorescent material illuminates the light receiving element through a half mirror or a dichroic mirror.

However, in the conventional fluorescent temperature sensor, it is necessary to perform both the inputting and the outputting of light at the other end of the single optical fiber or the optical fiber bundle that is a single bundle of multiple optical fibers, and because the alignment of the light source and the light receiving element to the optical fiber is complex, the manufacturing process is complex, and thus there are the drawbacks of reduced manufacturability and increased product costs.

On the other hand, while one may consider separating the optical fiber for projecting light onto the fluorescent material from the optical fiber that guides the light from the fluorescent material to the light receiving element, conversely the alignment between these optical fibers and the fluorescent material becomes complex. Furthermore, this has the drawback of producing a reduction in the measurement accuracy due to the reduced fluorescent light intensity of the fluorescent material as a whole due to the portion of the fluorescent material that receives the light from the light source being off-center.

In contemplation of the situation set forth above, the object of the present invention is to use a simple structure to provide a fluorescent temperature sensor with increased accuracy through increasing the fluorescent light intensity of the fluorescent materials.

### SUMMARY OF THE INVENTION

A fluorescent temperature sensor according to the invention is a fluorescent temperature sensor for producing a temperature signal from fluorescent light of a fluorescent material that has been optically stimulated, having a light projecting element for projecting light at the fluorescent material; a plurality of light conveying media for the projected light, for conveying, to the fluorescent material, light that is emitted by the light projecting element, disposed so that one end face thereof faces the light projecting element and disposed so that the other end thereof faces the fluorescent material; a light receiving element for receiving the fluorescent light that is emitted by the fluorescent material; a plurality of light conveying media for the received light, for conveying, to the light receiving element, light that is emitted by the first material, disposed so that one end face thereof faces the light receiving element and disposed so that the other end thereof faces the fluorescent material; and a signal processing circuit for generating a temperature signal from the output of the light receiving element; wherein the light conveying media for the projected light and the light conveying media for the received light are mutually separated and independent at one end side thereof to face the light projecting element and the light receiving element, and are bundled together to be mixed together at the other end thereof to face the fluorescent material.

Given the fluorescent temperature sensor as set forth below, one end side of the light conveying media for the projected light faces the light projecting element independently of the light conveying media for the received light, and one end side of the light conveying media for the received light faces the light receiving element independently from the light conveying media for the projected light, and thus the light conveying media can be connected easily to face directly the light projecting element and the light receiving element.

On the other hand, the other end side of the light conveying media for the projected light and of the light conveying media for the received light are bundled and mixed together to be disposed facing the fluorescent material. Because of this, these bundles of light conveying media need only be aligned to the fluorescent material, so neither the connection nor the adjustments are complex. Additionally, because the light conveying media for the projected light and the light conveying media for the received light are mixed in a single bundle of light conveying media, it is possible to project light uniformly onto the fluorescent material, to thereby increase the intensity of the fluorescent light, and, by extension, possible to increase the measurement accuracy.

A fluorescent temperature sensor according to the invention is the fluorescent temperature sensor as set forth above, wherein: the plurality of light conveying media for the projected light is made from a plurality of optical fibers for the projected light, and at least a portion of the plurality of optical fibers for the projected light is disposed so that the cores of the optical fibers are within the range of the directional characteristics of the light projecting element; and the plurality of light conveying media for the received light is made from a plurality of optical fibers for the received light, and is disposed so that the light receiving element is positioned within the range of the aperture angle of at least a portion of the optical fibers of this plurality of optical fibers for the received light.

Given the fluorescent temperature sensor according to the second invention, the light conveying media are optical fibers (optical fiber strands), and when light is conveyed by an optical fiber bundle that is a bundle of a plurality of these optical fiber strands, it is possible to cause the light that is produced by the light projecting element to be illuminated reliably into the core of the optical fiber, through positioning the cores of a portion of the optical fibers that structure the optical fiber bundle for the projected light to be within the range of the directional characteristics of the light projecting element. On the other hand, it is possible to cause the fluorescent light that is produced by the fluorescent material to be emitted reliably onto the light receiving element through positioning the light receiving element within the scope of the aperture angle of a portion of the optical fibers that structure the optical fiber bundle for the received light. This simple structure enables the light to be conveyed reliably, and enables the intensity of the fluorescent light of the fluorescent material to be caused to be uniform, making it possible to achieve stabilized temperature measurements.

### BRIEF DESCRIPTION OF THE DRAWINGS

FIG. 1 is an overall structural diagram of a fluorescent temperature sensor according to the embodiment.

FIG. 2 is an explanatory diagram illustrating a specific structure for the optical fibers for the projected light.

FIG. 3 is an explanatory diagram illustrating a specific structure for the optical fibers for the received light.

FIG. 4 is an explanatory diagram illustrating the state wherein the optical fibers for the projected light and for the received light are mixed.

FIG. 5 is a diagram illustrating the intensity of the fluorescent light when the optical fibers for the projected light and for the received light are mixed and light is projected.

### DETAILED DESCRIPTION OF THE INVENTION

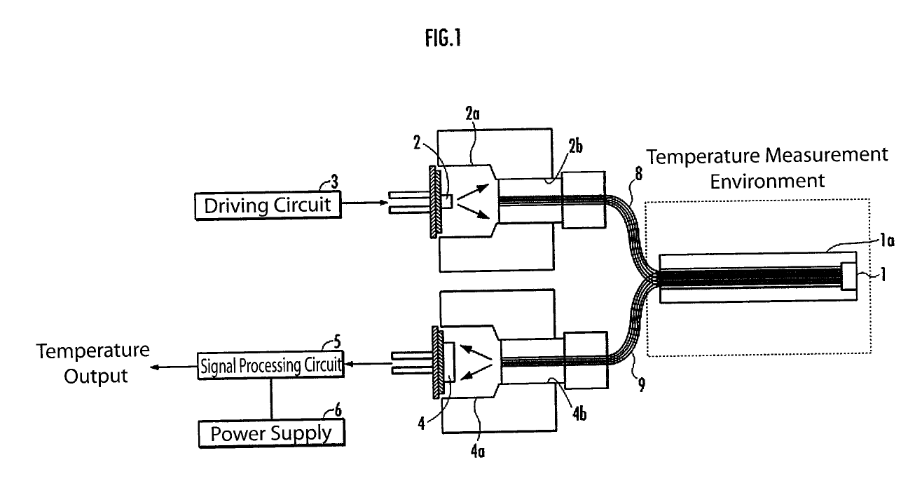

A fluorescent temperature sensor will be explained as one example of embodiment according to the present invention, in reference to FIG. 1 through FIG. 5.

The overall structure of the fluorescent temperature sensor according to the present embodiment will be explained in reference to FIG. 1. The fluorescent temperature sensor is provided with a fluorescent material 1 that exhibits fluorescent characteristics that vary with temperature, an LED 2 as a light projecting element for projecting light to the fluorescent material 1, a driving circuit 3 for driving the LED 2, and a photodiode 4, as the light receiving element, for receiving the fluorescent light that is emitted by the fluorescent material 1. Furthermore, a power supply 6 is connected to a signal processing circuit 5, and the electric power that is required for the operation of the fluorescent temperature sensor is provided by the power supply 6. Furthermore, the fluorescent temperature sensor is provided with optical fibers 8 for the projected light, for conveyed the light from the LED 2 to the fluorescent material 1, and optical fibers 9 for the received light, for conveying the fluorescent light of the fluorescent material 1 to the photodiode 4, as the light conveying media.

The fluorescent material is disposed so as to face the core portions of the optical fibers 8 and 9 in the center of the guard sheathes la that are provided so as to cover one end portion of the optical fibers 8 and 9 for the projected light and the received light.

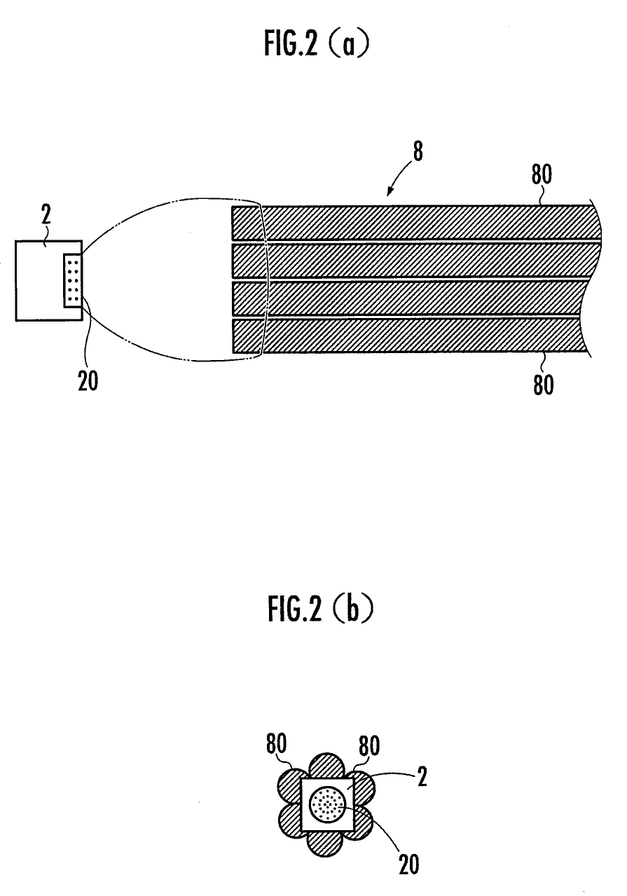

The LED 2 is a light emitting diode that has, as the emitted light color, a blue-spectrum wavelength, for example, and is disposed within an LED module 2a. The LED module 2a has a connector portion 2b to which the fiber 8 for the projected light connects, where the optical fiber 8 for the projected light, connected through this connector portion 2b, faces the light emitting portion 20 of the LED 2. (See FIG. 2.)

The driving circuit 3 generates a pulse electric current that is limited, by the control circuit, to the illumination time and the magnitude of the driving current that is required for the emission of light by the LED 2. For example, the driving circuit 3 applies to the LED 2, a pulse current of a specific magnitude to cause the light emission time of the LED 2, in a single measurement, to be somewhere between 1 ms and 500 ms, in accordance with the fluorescent material 1.

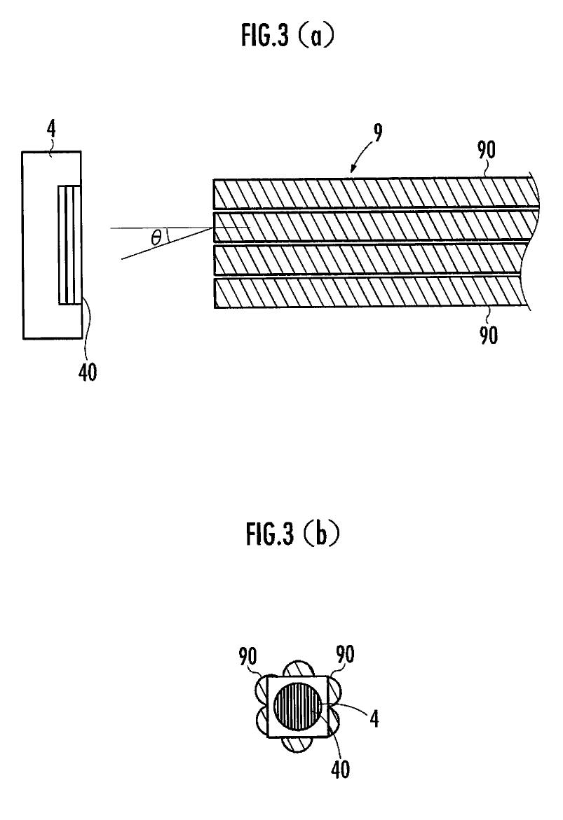

The photodiode 4 is disposed within the photodiode module 4a, and the optical flux of the light that is emitted (the brightness) is measured. The photodiode module 4a has a connector portion 4b that connects to the optical fibers 9 for the received light, where the optical fibers 9 for the received light, connected by the connector portion 4b, face the light receiving portion 40 of the photodiode 4. (See FIG. 3.)

The signal processing circuit 5 measures the attenuation characteristics of the fluorescent light of the fluorescent material 1, measured by the photodiode 4, and, in particular, measures the fluorescent light relaxation time. Specifically, the signal processing circuit 5 calculates and outputs the temperature of the temperature measurement ambient environment wherein the fluorescent material 1 exists, based on a corresponding relationship (including a data table, a map, or the like) between the temperature dependency of the fluorescent light relaxation time and the fluorescent material 1, established in advance.

Next a specific structure for the optical fibers 8 for the projected light and the optical fibers 9 for the received light will be explained in reference to FIG. 2 through FIG. 4.

FIG. 2(a) is a cross-sectional diagram along the axial line of the optical fibers 8, and FIG. 2(b) is a partial cross-sectional diagram of the optical fibers 8. The optical fibers 8 for the projected light are structured from an optical fiber bundle wherein multiple optical fiber strands 80 are bundled together. The optical fibers 8 for the projected light are bundled on one end side independently from the optical fibers 9 for the received light, and face the LED 2, where all or at least a portion of the optical fiber strands 80 that comprise the optical fibers 8 for the projected light is disposed so as to be positioned within the range of the direction characteristics of the LED 2 (the imaginary line in the figure).

FIG. 3(a) is a cross-sectional diagram along the axial line of the optical fibers 9, and FIG. 3(b) is a partial cross-sectional diagram of the optical fibers 9. The optical fibers 9 for the received light are structured from an optical fiber bundle wherein multiple optical fiber strands 90 are bundled together. The optical fibers 9 for the received light are bundled on one end independently from the optical fibers 8 for the projected light, and face the photodiode 4, and are disposed so that the light receiving portion 40 of the photodiode 4 is positioned within the range of the aperture angle θ of all or at least a portion of the optical fiber strands 90 that structure the optical fibers 9 for the received light.

Having one end of the optical fibers 8 for the projected light and one end of the optical fibers 9 for received light be separate and independent in this way enables the optical fibers and the LED 2 and the photodiode 4 to face each other directly, enabling the reception of the light to be performed easily and reliably.

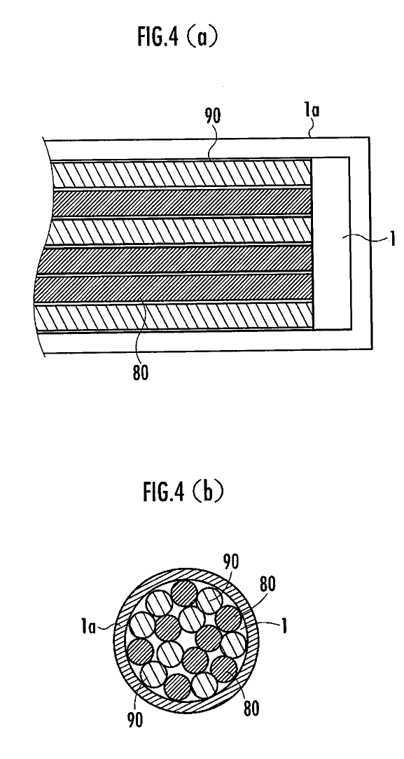

At the other end side of the optical fibers 8 and 9, as illustrated in FIG. 4(a) and FIG. 4(b), the bundling is performed so that the optical fibers 8 and 9 for the projected light and for the received light are mixed together, or in other words, so that at the cross-sectional surface at the other end of the optical fibers 8 and 9, the optical fibers 8 for the projected light and the optical fibers 9 for the received light will be mixed together randomly, so that there is essentially no bias, and then caused to face the fluorescent material 1.

This not only causes the optical fibers 8 and 9 to independently and separately face the LED 2 and the photodiode 4 on one end side, but structures a random mix fiber on the other end side.

The bundled optical fibers wherein the optical fibers 8 and 9 for the projected light and the received light being mixed together enables uniform projection of light into the fluorescent material 1.

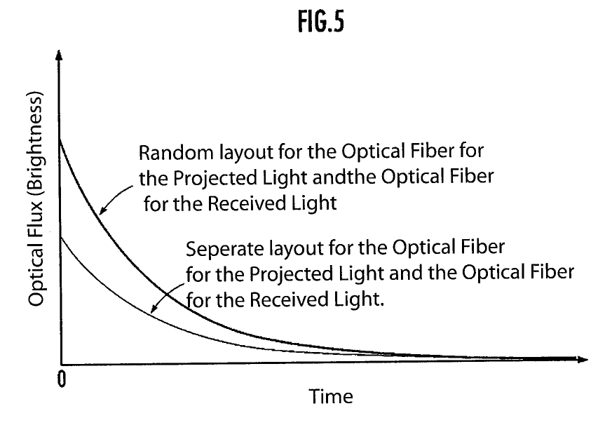

Because of this, when the optical fibers 8 and 9 for the projected light and for the received light are mixed so as to exhibit the relationship between time and optical flux (brightness) of FIG. 5, it is possible to obtain approximately twice the optical flux of the fluorescent light when compared to the case wherein these optical fibers 8 and 9 are separated when light is projected into the fluorescent material 1. This not only enables an improvement in the stability of the temperature measurement, but also achieves an improvement in the measurement accuracy.

1. A fluorescent temperature sensor for producing a temperature signal from fluorescent light of a fluorescent material that has been optically stimulated, comprising:
a light projecting element projecting light at the fluorescent material;
a plurality of light conveying media for the projected light, conveying, to the fluorescent material, light that is emitted by the light projecting element, disposed so that one end face thereof faces the light projecting element and disposed so that the other end thereof faces the fluorescent material;
a light receiving element receiving the fluorescent light that is emitted by the fluorescent material;
a plurality of light conveying media for the received light, conveying, to the light receiving element, light that is emitted by the first material, disposed so that one end face thereof faces the light receiving element and disposed so that the other end thereof faces the fluorescent material; and
a signal processing circuit generating a temperature signal from the output of the light receiving element; wherein
the light conveying media for the projected light and the light conveying media for the received light are mutually separated and independent at one end side thereof to face the light projecting element and the light receiving element, and are bundled together to be mixed together at the other end thereof to face the fluorescent material.

2. The fluorescent temperature sensor as set forth in claim 1, wherein:
the plurality of light conveying media for the projected light is made from a plurality of optical fibers for the projected light, and at least a portion of the plurality of optical fibers for the projected light is disposed so that the cores of the optical fibers are within the range of the directional characteristics of the light projecting element; and
the plurality of light conveying media for the received light is made from a plurality of optical fibers for the received light, and is disposed so that the light receiving element is positioned within the range of the aperture angle of at least a portion of the optical fibers of this plurality of optical fibers for the received light.
